(19) United States
(12) Patent Application Publication
(10) Pub. No.: US 2026/0008514 A1
(43) Pub. Date: Jan. 8, 2026

(54) BICYCLE WITH MODIFIED PEDALLING SYSTEM

(71) Applicant: Leonardo GRIECO, Marotta (PU) (IT)

(72) Inventor: Leonardo GRIECO, Marotta (PU) (IT)

(21) Appl. No.: 18/992,271

(22) PCT Filed: Jul. 12, 2023
(86) PCT No.: PCT/IB2023/057139

§ 371 Date: Jan. 8, 2025

(30) Foreign Application Priority Data
Jul. 13, 2022 (CH) CH000835/2022

(51) Int. Cl. B62M 3/06; B62J 1/08; B62M 9/02; B62M 11/06

(52) U.S. Cl. CPC B62M 3/06; B62J 1/08; B62M 9/02; B62M 11/06

(57) ABSTRACT

A bicycle in which each of the two pedals is mounted on a crank with a lever arm which is variable during pedalling, the crank comprising a proximal portion connected to the chainring and a distal portion on which the pedal is mounted, in which the distal portion is pivoted to the proximal portion, thus being able to extend away from the chainring, and an elastic return means is provided which is located between said two crank portions and tends to counteract extension of the crank and draw the distal portion back towards the proximal portion.

### BACKGROUND OF THE INVENTION

The invention relates to an improved bicycle.

The bicycle is a means of transport familiar to everyone and certainly does not need to be described in detail. In order to understand the present invention, it is sufficient to recall that the transmission of known bicycles is almost universally based on a chainring that transmits motion, by means of a chain, to a sprocket integral with the rear wheel. In the presence of a gear-change mechanism, the rear sprocket and possibly the chainring may have multiple gears, but the principle now illustrated does not change.

Each of the two pedals is connected to the chainring via a crank, the length of which substantially determines the lever arm exerted by the rider. The bicycle drive system can be thought of as a lever in which the fulcrum is the axis of rotation of the chainring, the useful force is applied to the pedal, and the resistance is typically represented by the chain tension with a lever arm substantially equal to the diameter of the chainring.

The length of the cranks is almost standard at approx. 170 mm. The most important fact here is that, since the crank is a rigid member, this length remains unchanged throughout pedalling, i.e. during both the active thrust phase and the return phase.

Another disadvantage of conventional bicycles equipped with a gear-change mechanism resides in the transmission system because the “motor” (provided by the pedal axle) and the transmission are one and the same, such that changing the speed ratio changes the diameter of the wheel meshing with the chainring, and consequently the lever arm with respect to the pedals also changes. The applicant has identified that this is a disadvantage.

### SUMMARY OF THE INVENTION

The applicant realised that the fixed lever arm, determined by the crank, limits the efficiency of conventional bicycles and set itself the object of overcoming this limitation. Starting from this intention, the idea underlying the invention is to provide a bicycle in which the lever arm between pedal and chainring is cyclically variable during pedalling.

The object is therefore achieved with a bicycle according to claim 1, in which:

the crank comprises a first proximal arm connected to the chainring and a second distal arm on which the pedal is mounted, in which the distal arm is pivoted to the proximal arm, thus being able to extend away from the proximal arm and the chainring, and an elastic return means is provided between said two arms which tends to draw the distal arm back toward the proximal arm.

The applicant has found that extending the crank enables a significant increase in the lever arm and, consequently, in propulsive force. It should be noted that the pedal moves away from the axis of rotation of the chainring under the effect of pedalling itself, gaining lever arm, during the active phase of pedalling; the elastic return means then allows the pedal to return to position before the next thrust. Pedalling becomes more efficient.

It should be noted that, in order to achieve greater thrust, the focus in the prior art has always been on gear-change mechanisms, but none ever thought to the lever between the pedal and chainring.

Additional preferred aspects of the invention are the subject matter of the dependent claims.

A further object of the invention is to overcome the above-mentioned disadvantage, namely, of the lever arm between the point of force application (on the pedals) and the position of the chain which depends on the engaged speed ratio.

In accordance with this further object, one aspect of the invention is a bicycle transmission system, comprising a pair of pedals and a chain for transmitting motion to the rear wheel of the bicycle, the system further comprising a series of gears which includes a first gearwheel directly set in rotation by the bicycle pedals, a second gearwheel driven by said first gearwheel, and a third gearwheel which is driven by the second gearwheel and is integral, on the same axis of rotation, with a group of sprockets forming a gear-change mechanism and meshing with the transmission chain.

The applicant considers that said gear transmission system allows the rider to develop maximum power at all times regardless of the selected speed ratio.

### DESCRIPTION OF THE INVENTION

The elastic return means is preferably a spring, for example a helical spring. Said spring has a first end attached to the proximal portion and a second end attached to the distal portion. In one preferred embodiment, said elastic element is connected to an end point of the distal crank portion and to an intermediate point of the proximal portion.

The distal portion is preferably has a shorter length than the proximal portion. According to a preferred proportion, the proximal portion accounts for 60% to 70% of the length of the fully extended crank. The proximal portion preferably has a length of from 160 mm to 180 mm, more preferably 175 mm, while the distal portion advantageously has a length of from 70 mm to 100 mm, and preferably 80 mm.

The transmission system may comprise a conventional chain directly between chainring and sprocket or, according to another aspect of the invention, has a gear cascade, i.e. a plurality of meshing gearwheels. A chain may be provided between the last gearwheel of the cascade and the sprocket.

In a preferred embodiment, a bicycle gear-change mechanism can be associated with one wheel of said gear cascade, preferably with a last wheel connected to the sprocket with a chain. In addition, or alternatively, a bicycle gear-change mechanism can be associated with the sprocket.

An additional preferred aspect of the invention relates to a saddle with a position adjustable in the longitudinal direction, i.e. in the front-to-rear direction of the bicycle. This adjustability makes it possible to find an ideal position for pedalling efficiency.

The saddle is preferably attached to an internal tube that slides telescopically into another, outer tube, such that the position of the saddle can be adjusted by sliding the internal tube relative to the outer tube.

Another preferred aspect of the invention relates to the bicycle front wheel having a smaller diameter than the rear wheel. The applicant has found that differentiating the diameter of the wheels by providing a smaller front wheel has the effect of relieving the load on the rear wheel and decreases pedalling effort. This is because, in conventional bicycles, the weight is transferred mainly on the rear wheel (about 70%); the smaller front wheel rebalances the weight distribution, preferably to around 50/50 between front and rear.

A bicycle according to the invention can, of course, be equipped with a bicycle gear-change mechanism associated with the chainring and/or sprocket.

### DESCRIPTION OF THE FIGURES

The invention is now described with reference to a preferred embodiment shown schematically in FIG. 1.

FIG. 1 shows a bicycle according to an exemplary embodiment of the invention.

FIG. 2 is a diagram of the transmission system in a preferred embodiment of the invention.

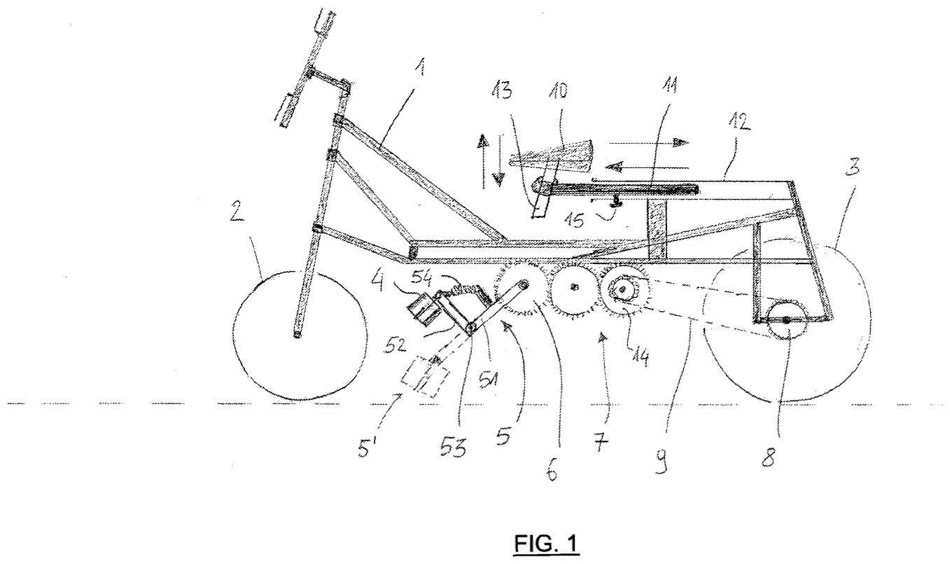

FIG. 1 shows the following essential parts.
1 Frame
2 Front wheel (of smaller diameter than the rear wheel 3)
3 Rear wheel (of greater diameter than the front wheel 2)
4 Pedal
5 Extensible crank
6 Chainring
7 Gear transmission
8 Sprocket of the rear wheel 3
9 Transmission chain
10 Saddle
11 Saddle support tube
12 Outer tube where the tube 11 slides
13 Tube for adjusting the height of the saddle 10.

With reference to crank 5, it can be noted it is made of a first portion 51 and a second portion 52, pivoted with a pin 53. The portion 51 is also denoted proximal because it is located by the chainring 6, while the portion 52 is denoted distal. The pedal 4 is mounted on the distal portion 52.

Both the proximal portion 51 and distal portion 52 can be substantially straight as shown or have another shape.

A spring 54 connects the proximal portion 51 to the distal portion 52, acting as an elastic return means. As is apparent, the spring 54 is preferably attached substantially at the end of distal portion 52, where the pedal 4 is also mounted, and is attached at an intermediate point, preferably about midway, of the proximal portion 51.

The figure shows the position 5′ (dashed line) of the fully extended crank, with the distal portion substantially aligned with the proximal portion. In this position 5′, the spring 54 is tensioned and tends to recall the distal portion 52 back towards the chainring 6.

It will be understood that during the active phase of pedalling, the thrust on the pedal 4 overcomes the resistance of spring 54, bringing the crank 5 to the extended configuration 5′ and increasing the lever arm relative to the axle of the chainring 6; in the return phase (while applying thrust to the other pedal), the crank 5 bends forming an angle due to the return action of spring 54, and then extends again in the next active thrust phase.

The so obtained lever arm (distance between pedal 4 and axle of chainring 6) varies with each turn of pedalling from a maximum value corresponding to the fully extended crank 5′, to a minimum value corresponding to the crank retracted under the return action of the spring 54.

The figure shows an embodiment in which the chainring 6 meshes with a series of other gearwheels forming a gear cascade 7; the last gearwheel 14 transmits motion to the sprocket 8 with the chain 9. A gear-change mechanism can be mounted coaxially on wheel 14 and/or sprocket 8.

The figure also illustrates the longitudinal adjustment of saddle 10 by way of telescopic tubes 11, 12. Tube 11 slides relative to tube 12 (attached to frame 1) and is locked in the desired position with a clamp 15.

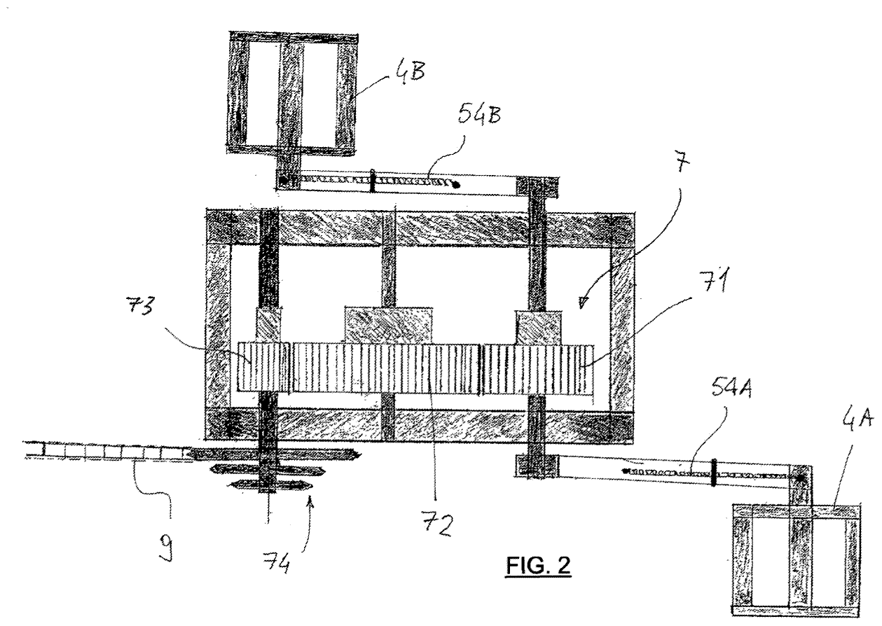

Turning to FIG. 2, a preferred embodiment of a gear transmission system 7 is shown which comprises a first gearwheel 71 driven by pedals 4A and 4B, a second gearwheel 72, and a sprocket 73. A gear-change mechanism 74 comprising gearwheels of different diameters which can mesh with a chain 9 depending on the gear engaged is mounted integrally on the same axle with sprocket 73. The centre wheel 72 serves to impart the correct direction of motion and as a spacer between wheels 71 and 73.

In the example of FIG. 2, both pedals 4A and 4B are equipped with an extensible crank with return spring 54A, 54B (as in FIG. 1); however, the transmission of FIG. 2 according to the invention is also applicable to bicycles with conventional cranks.

1-11. (canceled)

12. A bicycle, comprising:
at least one chainring operable by a pair of pedals and a transmission system between said at least one chainring and a rear wheel of the bicycle,
wherein each of the pair of pedals is mounted on a crank having a lever arm which is variable during pedalling, the crank including a first proximal portion connected to the chainring and a second distal portion on which the pedal is mounted, wherein the distal portion is pivoted to the proximal portion, thus being able to extend away from the at least one chainring; and
an elastic return is provided that is located between said first proximal portion and the second distal portion of the crank and tends to counteract extension of the crank and return the second distal portion back towards the first proximal portion.

13. The bicycle according to claim 12, wherein said elastic return includes a spring having a first end attached to the first proximal portion and a second end attached to the second distal portion.

14. The bicycle according to claim 12, wherein the second distal portion has a shorter length than the first proximal portion.

15. The bicycle according to claim 14, wherein the first proximal portion accounts for between 60% and 70% of a length of the fully extended crank.

16. The bicycle according to claim 14, wherein the first proximal portion has a length from 160 mm to 180 mm.

17. The bicycle according to claim 12, wherein the transmission system comprises a plurality of gearwheels forming a gear cascade.

18. The bicycle according to claim 17, wherein one of the plurality of gearwheels in the gear cascade is associated with a gear-change mechanism.

19. The bicycle according to claim 12, further comprising a saddle with an position adjustable in a longitudinal direction.

20. The bicycle according to claim 19, wherein the saddle is attached to an internal tube that slides telescopically into an outer tube, such that the position of the saddle can be adjusted by sliding the internal tube relative to the outer tube.

21. The bicycle according to claim 12, wherein a front wheel of the bicycle has a smaller diameter than the rear wheel.

22. A bicycle transmission system, comprising:
a pair of pedals; and
a chain for transmitting motion to a rear wheel of a bicycle;
a series of gears that includes a first gearwheel directly set in rotation by the bicycle pedals, a second gearwheel driven by said first gearwheel, and a third gearwheel which is driven by the second gearwheel and is integral, on a same axis of rotation, with a group of sprockets forming a gear-change mechanism and meshing with the transmission chain.
